(19) United States
(12) Patent Application Publication
(10) Pub. No.: US 2008/0085641 A1
(43) Pub. Date: Apr. 10, 2008

(54) TROLLING MOTOR CABLE COVER

(76) Inventor: Lance J. Williams, Billings, MO (US)

Correspondence Address: BLACKWELL SANDERS LLP, 4801 Main Street, Suite 1000, KANSAS CITY, MO, 64112, US

(21) Appl. No.: 11/539,890

(22) Filed: Oct. 10, 2006

(51) Int. Cl. B63H 21/17; B60L 11/00

(52) U.S. Cl. 440/6

(57) ABSTRACT

A trolling motor with sensor unit construction is provided. A sensor is mounted to a lower portion of the trolling motor preferably adjacent the trolling motor propulsion unit. A signal conductor extends from the sensor unit connecting it to a display device. The signal conductor is mounted to a tube portion of the trolling motor with a resiliently deformable cover having a pair of channels formed therein extending between opposite ends of the cover. The tube is received within one of the channels and the cable is received within the other of the channels to removeably mount the signal conductor to the tube. The cover has an open side permitting receipt therethrough of the tube and the second channel has an open side for receipt therethrough of the cable. The open side of the second channel opens into the first channel.

### BACKGROUND OF THE INVENTION

Trolling motors are well known in the industry. They typically include an elongate tube that extends between a propulsion unit and a head unit. Oftentimes the tube is extensible in length and sometimes is moveable up and down within a boat mounting mechanism to adjust the depth of the propulsion unit and propeller within the water when the propulsion unit is in a down orientation for propelling a boat or the like. The boat mounting mechanism can be used to effect locking the trolling motor in a down position. The head can include a control unit with a steering control and throttle or the trolling motor may be provided with a foot operated device for controlling both the speed and the direction of the boat while leaving the hands free to perform other tasks like fishing.

Oftentimes, sensors can be associated with a watercraft, and in particular, the trolling motor, to provide certain information to the boat operator or someone else within the boat. Such sensors can include a sonar device for determining underwater structure, water depth as well as fish location. These devices are oftentimes called fish finders. Other sensors can also be provided to sense, for example, craft speed in the water, water temperature, pH and water color all needing to be immersed in the water to operate. One convenient means for selectively positioning one or more sensors within the water is to mount them to a trolling motor. In order to operate the sensors, a signal conductor connects the sensor unit or transducer to a display readout, for example, an LCD screen or other digital form of display or analog display device. The signal conductor though is often unprotected. One way of securing the signal conductor is to secure it to the trolling motor tube, as for example, with cable ties. This method of securement, even though convenient and inexpensive, is unsightly and still leaves a significant portion of the signal conductor, which may be in the form of an insulated wire cable, exposed for abrasion, cutting, or the like. Additionally, it would be convenient to have the sensor unit or transducer module with sensor, its associated signal conductor and display easily removable and transferable to another trolling motor, watercraft or the like.

There is thus a need for an improved means to attach a signal conductor to a trolling motor that will provide improved protection for the signal conductor and its easy installation and removal.

### SUMMARY OF INVENTION

The present invention involves the provision of a trolling motor with sensor that includes a mount for securement to a water craft, a tube secured to the mount and having first and second ends. A propulsion unit is secured to the tube adjacent the first end and a head unit is secured to the tube adjacent to the second end. The head unit may include a control unit operable to control operation of the propulsion motor and the direction of propulsion. A sensor is carried by the tube and includes a signal conductor extending from the sensor for providing a signal to a display device. A elongate cover has first and second longitudinally extending channels. The first channel has an elongate longitudinal first opening for receiving a portion of the tube therethrough to secure the cover to the tube. The second channel has a portion of the signal conductor therein for securing the signal conductor to the tube enclosing the conductor within the second channel and securing the conductor to the tube. The first channel can be formed by a pair of longitudinally extending flanges defining an opening between free edges thereof and spaced sufficiently for the tube to be received therethrough. The flanges are resiliently deformable allowing releasable securement of the cover to the tube.

### BRIEF DESCRIPTION OF THE DRAWINGS

FIG. 1 is a perspective view of a trolling motor mounted to a watercraft with the trolling motor in a down and craft propelling orientation and showing the use of a plurality of covers on the lower portion of the trolling motor tube.

FIG. 2 is an enlarged sectional view taken along the line 2-2 of FIG. 4.

FIG. 3 is an enlarged fragmentary perspective view of the cover.

FIG. 4 is an enlarged view of the trolling motor showing the tube, propulsion unit and head unit associated with one another showing the use of a single cover on the lower portion of the trolling motor tube.

Like numbers throughout the various Figures designate like or similar parts and/or construction.

### DETAILED DESCRIPTION

The reference numeral 1 designates generally a watercraft including a boat hull 2, seats 3, an optional primary propulsion unit 4 and a secondary propulsion unit 5. The hull 2 may be of any suitable shape and type. The primary propulsion unit 4 can be of any suitable type, for example, an inboard motor, an outboard motor, a combination inboard/outboard, sails or the like. Secondary propulsion unit 5 is a trolling motor that is powered electrically and can be mounted adjacent to the bow or the stem and can be a transom mount unit or mounted to a bow or bow cowling.

Trolling motors are well known in the art and as shown in the illustrated structure, the trolling motor 5 includes a propulsion unit 8 mounted to a tube 9. The tube 9 is in turn is mounted to a mounting device 10 which is shown as a pivoting type permitting the trolling motor 5 to be transported with the watercraft I in an up and out of the water position and can be lowered for the propulsion unit 8 to be in the water for powering the watercraft. The tube 9 may be moveably mounted within the mount 10 as with a set screw 11 to permit depth adjustment of the propulsion unit 8 as desired by the user. The propulsion unit 8 includes an internal motor in the housing 14 which drives a propeller 15 upon command from a control unit 17 and can be powered by one or more batteries 18. The batteries 18 can be charged prior to use of the watercraft 1 and/or can be charged by the primary propulsion unit 4 as desired. The control unit 17 may be part of the head unit 21 or may be a foot pedal style control unit. The control unit 17 is operable for controlling both direction of propulsion and hence movement of the watercraft 1 and the speed (angular velocity) of the propeller 15 and hence the speed of the watercraft 1 relative to the water.

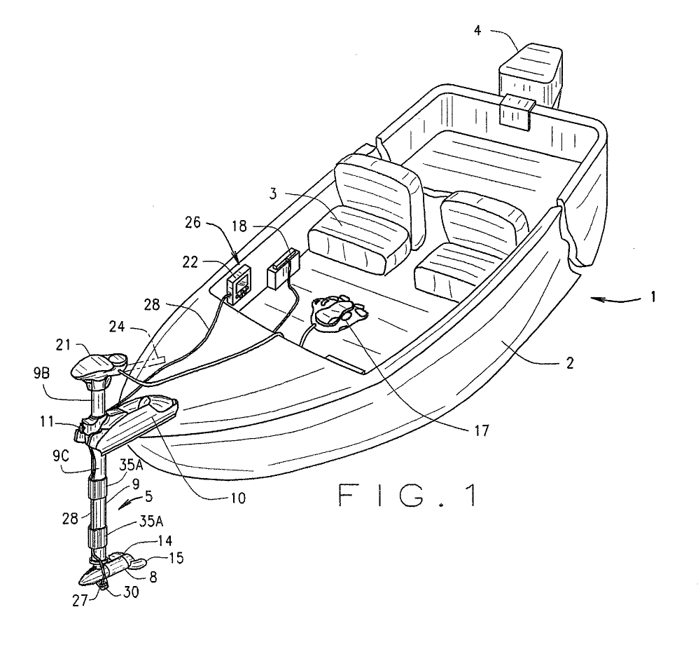

If the control unit 17 is part of the head 21, a hand throttle 24 (shown in phantom in FIG. 1). The head 21 is preferably constructed so as to provide an indication to the user of the direction of drive by the propulsion unit 8. Some trolling motors 5 can be provided with a form of autopilot which will maintain the position and/or direction of a boat in accordance with some transmitted and received signal or received signal, e.g., a GPS signal and programmed command.

In the operation of a watercraft 1, and in particular when fishing, a large array of electronics can be utilized by the operator. Some typical electronic devices include sonar units which will provide an indication of bottom structure and depth and in addition, can function as a fish locator indicating the presence and location of fish in proximity to the watercraft 1. Some fish locators can send signals laterally as well as downwardly. The electronics can further include a speed sensor to indicate the speed of the watercraft 1, water temperature, water pH and even water color, all providing various information to the watercraft operator or passenger as is known. Sensors are provided to sense the various parameters as well as a transducer which has a sensor to receive and process a transmitted signal back, for example, a sonar signal from a sonar transmitter to provide data to a display unit 26 for viewing by the operator or passenger. The display unit 26 may be in the form of a plasma or LCD screen 22, analog gauges, digital LCD gages or the like. The display unit 26 is connected to a sensor unit 27 via a signal conductor 28 which can be in the form of an insulated wire cable. The sensor unit 27 is mounted to the trolling motor 5 preferably adjacent the propulsion unit 8, e.g., with a bracket 30 that can be secured to the tube 9 or the propulsion unit 8 for immersion in the water when the propulsion unit 8 is also immersed in the water. The conductor 28 can be shielded fiber optic, insulated metallic wires or any other suitable signal conductor operable to transmit a signal from the sensor unit 27 to the circuitry operating the display 26. The conductor 28 may also provide power to the sensor 27 and its components or signals for transmission from the sensor unit. A signal may also be generated in and/or transmitted from the sensor unit 27, for example, a sonar signal may be generated and broadcast into the water. The reflected return signal is received by a sensor pickup or receiver in the sensor unit 27 and then transmitted to the circuitry for the display 26, e.g., to show bottom contour and fish location. The sensor unit 27 may also include a thermocouple, a speed sensor or the like.

As shown, the conductor 28 is mounted to the tube 9 by a cover 35. As best seen in FIGS. 3, 4 the cover 35 is an elongate structure having first and second longitudinally extending channels 37, 38. In a preferred embodiment, the channel 38 opens into the channel 37 at an open side portion 39 along the length of the channels 37, 38. In a particularly preferred embodiment, the cover 35 is an extrusion that can be formed of either a metal alloy or a polymeric material or a reinforced polymeric material. The channel 37 has an elongate longitudinally extending opening 40 formed between the free edges 41, 42, of curved flanges 43, 44. The opening 40 is sized to receive the tube 9 therethrough upon flexing of the flanges 43, 44 to expand the width of the opening 40 in a resiliently deformable manner. When the tube 9 is received in the channel 37 the flanges 43, 44 will engage the outer surface 45 of the tube clamping the cover 35 to the tube 9. The interior surfaces 46, 47 of the flanges 43, 44 conform generally to the exterior shape of the tube 9. The flanges 43, 44 are connected by a longitudinally extending bight portion 49 containing the channel 38. Typically, the tube 9 has a generally round transverse cross section. In such event, the circumscribed angle of arc A is no larger than about 145° and is preferably in the range of between about 90° and about 120°, while 110° for the angle A has been found acceptable when the cover 35 is made of a polymeric material such as polyvinylchloride (PVC). The cover may also be made of polypropylene, nylon, a reinforced polymeric material, etc. The thickness of the flanges 43, 44 may be on the order of 0.1 inches. In a preferred embodiment, the transverse cross sectional shape of the cover 35 is uniform along its length to permit its formation by extrusion or other simple molding or forming technique. The channel 38 is sized and shaped to receive the conductor 28 therein to extend between opposite ends of cover 35 and to secure the conductor 28 to the trolling motor 5 and preferably the tube 9. Because the sensor 27 is preferably permanently mounted to the conductor 28 in a waterproof manner, it is not easily removable and is typically larger than the conductor. In order to maintain the cover 35 in a sleek profile, the channel 38 is preferably just large enough to receive the conductor 28 therein. By the channel 38 opening into the channel 37 at the open side 39, the conductor 28 can be inserted easily into the channel 38 between opposite ends of the cover 35. The conductor 28 is placed into the channel 38 and then the cover 35 is mounted to the tube 9 by moving the tube 9 through the opening 40. The position of the conductor 28 about the tube 9 can be easily adjusted by turning the cover 35 on the tube 9. While there is a sharp transition shown between the channels 37 and 38 there need not be. The channel 38 may be formed as space left over and not occupied by the tube 9 when the tube is in the channel 37.

Some trolling motors 5 have a plurality of tube sections which may be of different diameters. In such case, a plurality of different size covers 35 may be provided. Additionally, the tube 9 varies in length and diameter from trolling motor to trolling motor. By the proper selection of material from which the cover 35 is made, it may be easily cut to length to accommodate different length tubes 9. Additionally, some boaters will adjust the tube 9 to set the propulsion unit 8 to different depths which may lead to the need for a different length cover 35. The cover 35 may be provided in a long length which may be easily cut to the desired length for a particular trolling motor set up. Additionally, the cover 35 may be mounted to the tube 9 in short length sections 35A (FIG. 4) and one or more covers 35 may be mounted to each of the upper and lower sections 9B, 9C of the tube 9. The sections 9B and 9C may have different diameters and may be telescopically connected to one another. A cover 35C may be provided above the mount 10 to secure the conductor 28 to the tube 9 above the mount 10 and may have different sized channels than the cover 35B. The conductor 28 extends from the trolling motors 5 to one or more displays 26. A plurality of conductors 28 may be mounted within a channel 38 in the event a plurality of independent sensors and displays 26 are used. The conductor 28 may include one or more wires or other suitable signal conducting elements and power cable. The width of the opening 40 is sufficient to receive one or more cables 28 therethrough. It has been found that a width on the order of ⅜-¾ inch and a channel depth of ⅜-¾ inch is acceptable. The tube 9 may have a diameter on the order of about 1 inch to about 1¾ inches or perhaps even larger. It is preferred that there be an interference fit between the tube 9 and the interior surfaces 46, 47 of the flanges 43, 44. e.g., the diameter of the formed channel 37 be on the order of 0.05 to 0.1 inches less than the diameter of the tube 9. The cover 35 may be easily removed for dismounting the sensor unit 27 and the conductor 28 from the trolling motor 5 and may be easily reinstalled a transferred to another trolling motor 5.

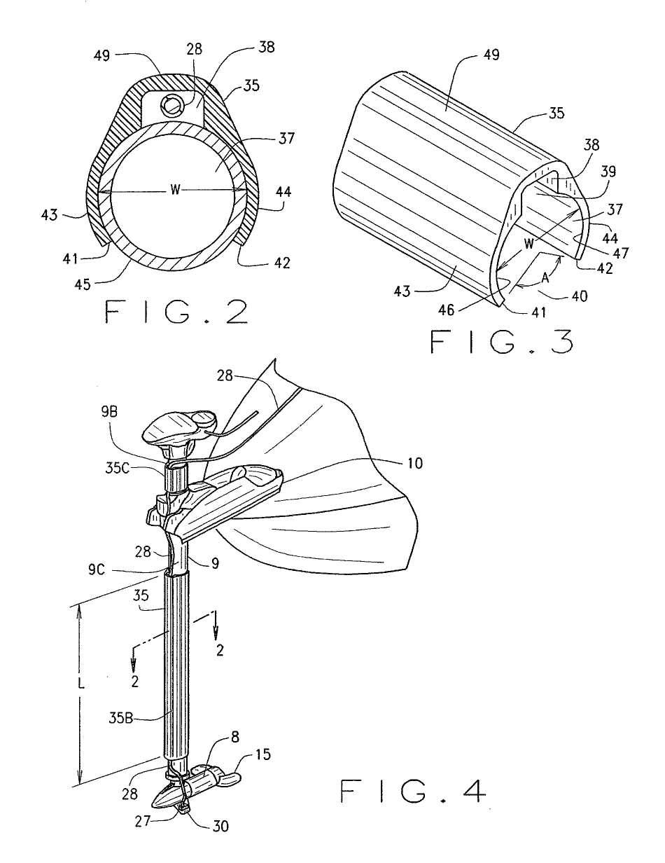

The covers 35, 35B, 35C have length L, FIG. 4, preferably at least about three times the transverse width W (or diameter when the channel 37 is round) of the channel 37, FIGS. 2, 3. The length L is preferably at least about four times W and most preferably at least about six times W.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A trolling motor with sensor unit comprising;
a mount for securement to a watercraft;
a tube secured to the mount and having first and second ends;
a propulsion unit secured to the tube adjacent the first end;
a head secured to the tube adjacent the second end;
at least one sensor carried by the tube, said at least one sensor being operably connected to a signal conductor extending from the at least one sensor; and
at least one elongate cover mounted to the tube and having first and second channels, said first channel having an elongate longitudinally extending first opening and having a portion of the tube received therein, said second channel having a portion of the signal conductor received therein.

2. The trolling motor with sensor unit of claim 1 wherein the cover including a pair of longitudinally extending flanges at least partially defining the first channel, said flanges each having a distal longitudinal edge spaced from one another defining the first opening, said flange edges being resiliently moveable toward and away from one another for receiving the tube therebetween.

3. The trolling motor with sensor unit of claim 2 wherein said second channel having a second opening into the first channel along the length of the second channel, said second opening having a width sufficient to receive the conductor therethrough.

4. The trolling motor with sensor unit of claim 3 wherein the tube is generally round in transverse cross section and the first opening encompasses no more than about 145° of arc of the tube.

5. The trolling motor with sensor unit of claim 3 wherein the first opening encompasses an arc of the tube in a range of between about 90° and about 120°.

6. The trolling motor with sensor unit of claim 3 wherein the sensor unit including a sonic transmitter and receiver.

7. The trolling motor with sensor unit of claim 6 including a control unit in the head for controlling operation of the propulsion unit.

8. The trolling motor with sensor unit of claim 6 including a foot pedal control operably connected to the propulsion unit.

9. The trolling motor with sensor unit of claim 3 wherein the cover having a generally uniform transverse cross sectional shape between opposite ends thereof.

10. The trolling motor with sensor unit of claim 9 wherein the at least one cover being an extrusion of polymeric material.

11. The trolling motor with sensor unit of claim 3 wherein there being a plurality of said covers mounted to the tube.

12. The trolling motor and sensor of claim 5 wherein the tube has a plurality of sections associated in telescoping relationship with at least two sections having different diameters each said section being received in a groove of a respective cover.

13. The trolling motor and sensor of claim 5 wherein the sensor is part of a transducer operable to send and receive signals.

14. A cover for removably mounting a signal conductor to a trolling motor tube, said cover including:
a pair of resilient longitudinally extending flanges each having an inner surface defining a first channel portion adapted to receive a trolling motor tube therein in gripping relationship, said flanges each having a longitudinal free edge, said free edges defining a longitudinal opening therebetween, said opening circumscribing an angle of arc of less than about 145°; and
a bight portion extending between and connected to the flanges, said bight portion forming a second channel opening into the first channel along the length thereof, said second channel being sized and shaped to receive a signal conductor therein.

15. The cover of claim 14 wherein the cover has generally uniform transverse cross sectional shape along the length of the cover.

16. The cover of claim 15 wherein the first channel having a generally round cross sectional portion with a diameter and the cover having a length of at least about three times the diameter.

17. The cover of claim 16 wherein the bight portion and flanges being integral and being a polymeric extrusion.

18. The cover of claim 14 wherein the angle of arc being in the range of between about 90° and about 120°.

19. The cover of claim 18 wherein the flanges being resiliently deformable when the opening is expanded by a trolling motor tube passing therebetween, said tube having a transverse diameter approximately equal to a transverse diameter of a generally round portion of the first channel.
